(19) United States
(12) Patent Application Publication
(10) Pub. No.: US 2009/0047029 A1
(43) Pub. Date: Feb. 19, 2009

(54) Waveform Shaping Apparatus, Receiver, Reception Module, and Remote Control Receiver

(75) Inventors: Fumirou Matsuki, Hyogo (JP); Shinji Yano, Kyoto (JP)

Correspondence Address: FISH & RICHARDSON P.C., P.O. BOX 1022, MINNEAPOLIS, MN, 55440-1022, US

(73) Assignee: ROHM CO., LTD., Kyoto (JP)

(21) Appl. No.: 11/577,113

(22) PCT Filed: Sep. 7, 2005
(86) PCT No.: PCT/JP05/16428

§ 371 Date: Apr. 12, 2007

(30) Foreign Application Priority Data
Oct. 15, 2004 (JP) 2004-302101

(51) Int. Cl. H04B 10/06; G06G 7/18

(52) U.S. Cl. 398/203; 327/336

(57) ABSTRACT

A waveform shaping apparatus has a first integrating circuit 152, a second integrating circuit 153, and a first comparison circuit 154. The first and second integrated circuits 152 and 153 are connected in series with each other, and so operate that, when a voltage signal loner than a predetermined period and larger than a predetermined amplitude is fed to the first integrating circuit 152, the voltage signal is made higher than a first reference voltage and is then output to he second integrating circuit 153 and, when the voltage signal fed to the first integrating circuit 152 is shorter than the predetermined period, the voltage signal is made lower than the first reference voltage and is then outputted from the second integrating circuit 153. The first comparison circuit 154 compares a voltage contained in the voltage signal outputted from the second integrating circuit 153 with the first reference voltage, and outputs the comparison result. This configuration prevents the waveform shaping apparatus from outputting an erroneous pulse resulting from a nose signal shorter than the time width of a control signal and larger than the amplitude of the control signal.

### TECHNICAL FIELD

The present invention relates to a waveform shaping apparatus for use in a remote control receiver or the like that receives control signals modulated with a carrier wave having a predetermined frequency.

### BACKGROUND ART

In a remote control receiver for receiving control signals modulated with a carrier wave having a predetermined frequency (in other words, a remote control receiver for receiving optical signals whose emission is controlled according to control signals superimposed on carrier waves), a demodulation circuit is used that reduces malfunctioning occurring in response to noise signals radiated from a fluorescent lamp or the like (see, for example, Patent Publication 1 listed below). The control signals here are those for remotely controlling a household electrical appliance or the like. FIG. 5 shows an example of a conventional remote control receiver 1. This configuration includes a demodulation circuit 50 that is designed to cope with reducing malfunctioning occurring in response to noise signals radiated from a fluorescent lamp or the like. As shown in FIG. 5, the demodulation circuit 50 includes a detection circuit 51, a transistor TrA, a first integrating circuit 52, a transistor TrB, a second integrating circuit 53, and a comparison circuit 54.

Now, with reference to FIGS. 5, 6, and 7, the operation of the demodulation circuit 50 will be described in detail. In an initial state, an integrating capacitor C1 is completely discharged. Thus, the voltage VcintA across the integrating capacitor C1 fulfills the relationship VcintA=0.1 V (which is the saturation voltage of a constant current source i2). Moreover, the voltage VcintB across an integrating capacitor C2 fulfills the relationship VcintB≈0.8 V (which equals the voltage VcintA plus the Vbe of the transistor TrB). In this state, the comparison circuit 54 outputs a low-level signal to an output terminal 55, and, based on this signal, a signal Vo shown in FIGS. 6 and 7 (that is, a signal obtained by inverting the output logic level of the comparison circuit 54, eventually a high-level signal.

When a voltage signal according to a control signal as mentioned above is fed to the detection circuit 51, the first integrating circuit 52 charges the integrating capacitor C1 with the differential current between the output current of the detection circuit 51 (that is, the collector current of the transistor TrA) and the constant current produced by the constant current source i2. The output current of the detection circuit 51 is so set as to be larger than the constant current produced by the constant current source i2, and moreover the differential current between those currents (that is, the charge current through the integrating capacitor C1) is larger than the constant current produced by a constant current source i1 (that is, the charge current through the integrating capacitor C2). Thus, the speed (time constant) at which the integrating capacitor C1 is charged is higher than the speed at which the integrating capacitor C2 is charged. Hence, as shown in FIG. 6, the voltage VcintA rises sharply. When the voltage VcintA rises sharply in this way, the transistor TrB becomes reversely biased between the base and emitter thereof, and thus turns into an OFF state.

When the transistor TrB turns into an OFF state, the current produced by the constant current source i1 flows through the integrating capacitor C2, and thus the integrating capacitor C2 starts to be charged. This current produced by the constant current source i1 is smaller than that produced by the constant current source i2, more precisely, smaller than the differential current between the current produced by the constant current source i2 and the collector current of the transistor TrA. Thus, the speed at which the integrating capacitor C2 is charged is lower than the speed at which the integrating capacitor C1 is charged. Hence, the voltage VcintB rises gently. When the relationship VcintB>VrefH becomes fulfilled, the comparison circuit 54 turns the output thereof from a low level to a high level, and thus the signal Vo, which is obtained by inverting it, turns from a high level to a low level.

In this way, the voltage VcintB rises and falls so as to describe straight lines, and, in addition, the comparison circuit 54 has hysteresis. This makes the comparison circuit 54 less likely to output erroneous pulses, and promises stable demodulation. Thus, the demodulation circuit 50 performs stable demodulation even when used in a noise-inflicted environment.

FIG. 7 is a diagram showing the waveforms of the voltages VcintA and VcintB as observed when a control signal as mentioned above is, along with a noise signal, fed to the remote control receiver 1. As shown in FIG. 7, even when the waveform of the voltage VcintA is unstable, the resulting variation of the voltage VcintB remains in the range between voltages VrefL and VrefH (that is, the voltage VcintB does not fall below the voltage VrefL again). This ensures stable demodulation even in a noise-inflicted environment.
Patent Publication 1: Japanese Patent Application Laid-open No. 2002-281571

### DISCLOSURE OF THE INVENTION

### Problems To Be Solved By the Invention

However, if a noise signal shorter than the time width of the above mentioned control signal and larger than the amplitude of the control signal (hereinafter, such a noise signal is referred to as an excessively large noise signal) is fed to the remote control receiver 1, the demodulation circuit 50 cannot keep the variation of the voltage VcintB within the range between the voltages VrefL and VrefH, and may thus output an erroneous pulse resulting from the excessively large noise signal. Specifically, it operates as follows.

FIG. 8 is a diagram showing the waveforms of the voltages VcintA and VcintB as observed when an excessively large noise signal shorter than the time width of a control signal and larger than the amplitude of the control signal is fed to the remote control receiver 1. As shown in FIG. 8, when an excessively large noise signal shorter than the time width of a control signal and larger than the amplitude of the control signal is fed to the remote control receiver 1, the voltage VcintA greatly rises, and this may be accompanied by the voltage VcintB rising above the voltage VrefH. Thus, even when the voltage VcintA varies so as to describe smooth straight lines, the demodulation circuit 50 may output an erroneous pulse resulting from the excessively large noise signal.

In view of the conventionally encountered inconveniences described above, it is an object of the present invention to provide a waveform shaping apparatus that does not output an erroneous pulse resulting from an excessively large noise signal shorter than the time width of a control signal and larger than the amplitude of the control signal.

### Means For Solving the Problem

To achieve the above object, according to one aspect of the present invention, a waveform shaping apparatus is provided with: a plurality of integrating circuits that are connected in series with one another and that so operate that, when a voltage signal longer than a predetermined period and larger than a predetermined amplitude is fed to a first-stage integrating circuit, the voltage signal is made higher than a first reference voltage and is then outputted to a succeeding-stage integrating circuit and, when the voltage signal fed to the first-stage integrating circuit is shorter than the predetermined period, the voltage signal is made lower than the first reference voltage and is then outputted from the succeeding-stage integrating circuit; and a first comparison circuit that compares a voltage contained in the voltage signal outputted from the succeeding-stage integrating circuit with the first reference voltage and that then outputs a comparison result. With this configuration according to the present invention, the plurality of integrating circuits so operate that the voltage of noise contained in the voltage signal fed to the first-stage integrating circuit is made lower than the first reference voltage. In this way, the waveform shaping apparatus prevents the first comparison circuit from outputting an erroneous pulse resulting from the voltage of the noise, but permits the first comparison circuit to output a proper pulse resulting from a voltage other than that of the noise.

In the above configuration according to the present invention, preferably, the first-stage integrating circuit includes a second comparison circuit that compares the voltage of the voltage signal fed to the first-stage integrating circuit with a second reference voltage and that, when the voltage of the voltage signal is higher than the second reference voltage, outputs a predetermined current, and the first-stage integrating circuit includes a third comparison circuit that compares the voltage of the voltage signal fed to the first-stage integrating circuit with a third reference voltage and that, when the voltage of the voltage signal is higher than the third reference voltage, outputs a predetermined current.

With this configuration, unless the voltage of noise is higher than the second or third reference voltage, the second or third comparison circuit does not output the predetermined current. Thus, the voltage of noise smaller than the second or third reference voltage is eliminated. In this way, the waveform shaping apparatus prevents the first comparison circuit from outputting an erroneous pulse resulting from the voltage of such noise.

In the above configuration according to the present invention, preferably, the first integrating circuit includes an integrating capacitor that is charged with the predetermined current outputted from the second comparison circuit, and the second integrating circuit includes an integrating capacitor that is charged with the predetermined current outputted from the third comparison circuit.

With this configuration, only while the voltage of noise is higher than the second or third reference voltage, the corresponding integrating capacitor is charged. Thus, the integrating capacitor is charged for a shorter period than in a case where the second or third comparison circuit is not provided, and the voltage charged in the integrating capacitor is accordingly lower. Thus, thanks to the provision of the first integrating circuit including the second comparison circuit and the integrating capacitor, and then thanks to the provision of the second integrating circuit including the third comparison circuit and the integrating capacitor, the voltage of the noise fed to the first integrating circuit becomes lower and lower, eventually becoming lower than the first reference voltage. In this way, the waveform shaping apparatus prevents the first comparison circuit from outputting an erroneous pulse resulting from the voltage of such noise.

According to another aspect of the present invention, a receiver is provided with: a photoreceptive device that optically receives control signals modulated with carrier waves having predetermined frequencies; a voltage conversion circuit that converts the signals optically received by the photoreceptive device into voltage signals; a frequency selection circuit that selects, from among the voltage signals, a voltage signal belonging to a predetermined frequency band and that then outputs the selected voltage signal; and the waveform shaping apparatus described above. Here, the plurality of integrating circuits so operate that, of what is contained in the voltage signal outputted from the frequency selection circuit, any voltage shorter than a predetermined period is made lower than the first reference voltage so as not to be outputted from the succeeding-stage integrating circuit.

With this configuration, the plurality of integrating circuits are provided in the stage succeeding the frequency selection circuit. Thus, the waveform shaping apparatus can make the voltage of noise included in the voltage signal outputted from the frequency selection circuit lower than the first reference voltage. In this way, in a remote control receiver including a photoreceptive device, a voltage conversion circuit, an amplification circuit, and a frequency selection circuit, it is possible to prevent output of an erroneous pulse resulting from the voltage of noise.

According to another aspect of the present invention, the waveform shaping apparatus described above may be formed integrally as a module. This module may be used in a remote control receiver or transmitter.

### Advantages of the Invention

According to the present invention, it is possible to prevent output of an erroneous pulse even if an excessively large noise signal shorter than the time width of a control signal and larger than the amplitude of the control signal is fed in on a one-shot basis.

### BRIEF DESCRIPTION OF DRAWINGS

FIG. 1 A diagram showing an outline of the internal configuration of a remote control receiver embodying the invention.

FIG. 2 A diagram showing the internal configuration of a waveform shaping circuit embodying the invention;

FIG. 3 A diagram showing the waveforms of the voltages appearing at relevant points when the remote control receiver 100 receives a noise signal.

FIG. 4 A diagram showing the waveforms of the voltages appearing at relevant points when the remote control receiver 100 receives a control signal.

FIG. 5 A diagram showing the internal configuration of a conventional remote control receiver.

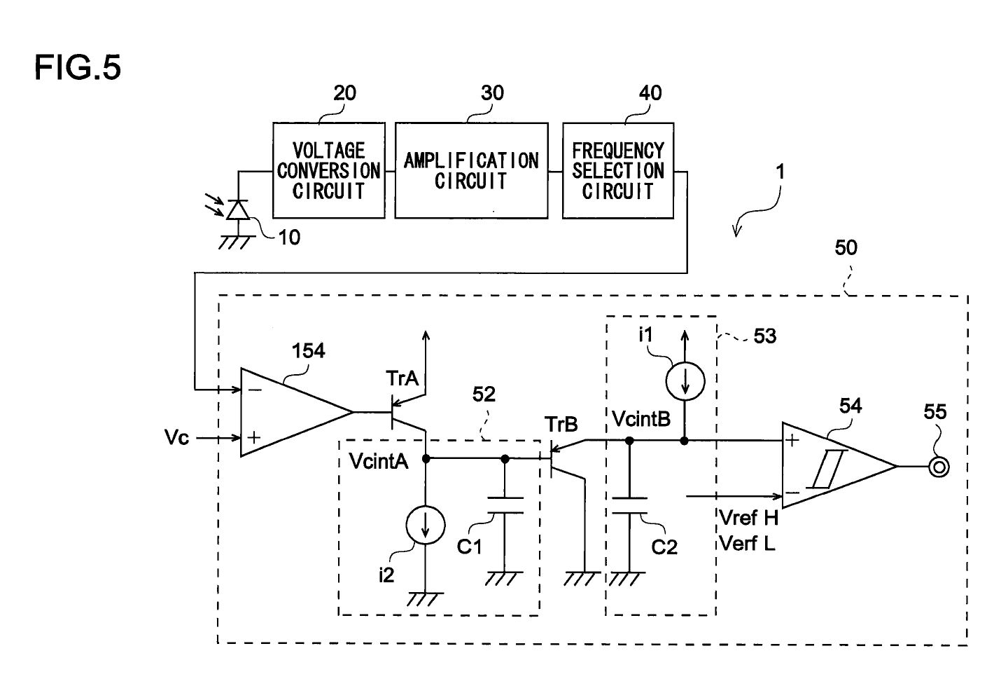

FIG. 6 A diagram showing the waveforms of the voltages appearing in an integrating circuit in a conventional remote control receiver (1 of 3).

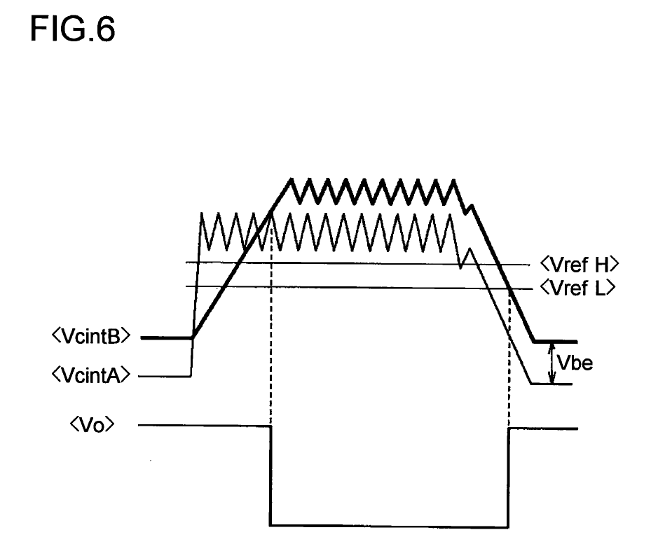

FIG. 7 A diagram showing the waveforms of the voltages appearing in an integrating circuit in a conventional remote control receiver (2 of 3).

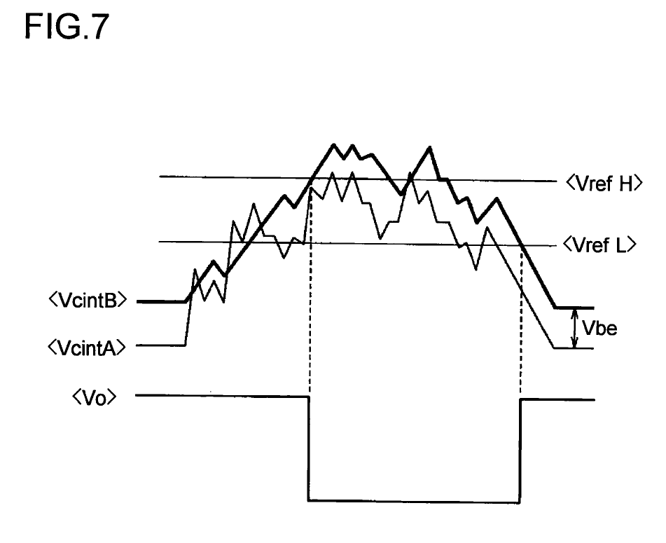

FIG. 8 A diagram showing the waveforms of the voltages appearing in an integrating circuit in a conventional remote control receiver (3 of 3).

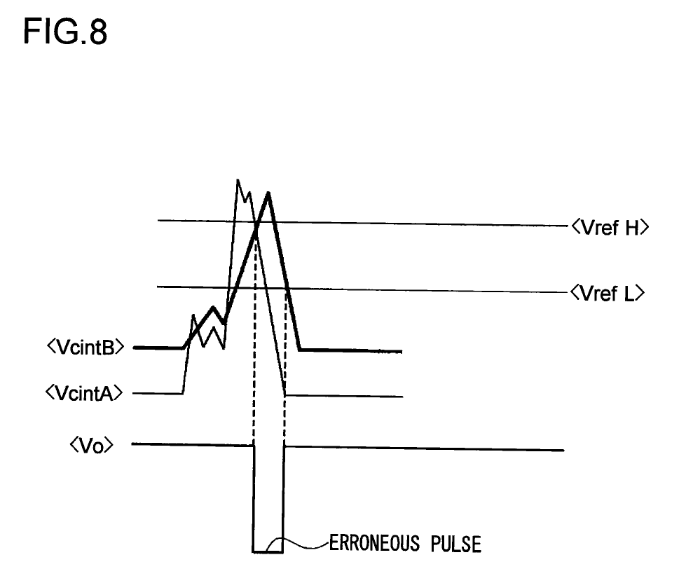

### LIST OF REFERENCE SYMBOLS

10 Photodiode

20 Current/Voltage Conversion Circuit

30 Amplification Circuit

40 Frequency Selection Circuit

50 Demodulation Circuit

51 Detection Circuit

52 First Integrating Circuit

53 Second Integrating Circuit

54 Comparison Circuit

55 Output Terminal

100 Remote Control Receiver

110 Photoreceptive Device

120 Current/Voltage Conversion Circuit

130 Amplification Circuit

140 Frequency Selection Circuit

150 Waveform Shaping Circuit

151 Signal Detection Circuit

152 First Integrating Circuit

152a Second Comparison Circuit

152b First Integrating Capacitor

153 Second Integrating Circuit

153a Third Comparison Circuit

153b Second Integrating Capacitor

154 First Comparison Circuit

### BEST MODE FOR CARRYING OUT THE INVENTION

Hereinafter, the configuration of a waveform shaping circuit (waveform shaping apparatus) embodying the present invention will be described with reference to the accompanying drawings.

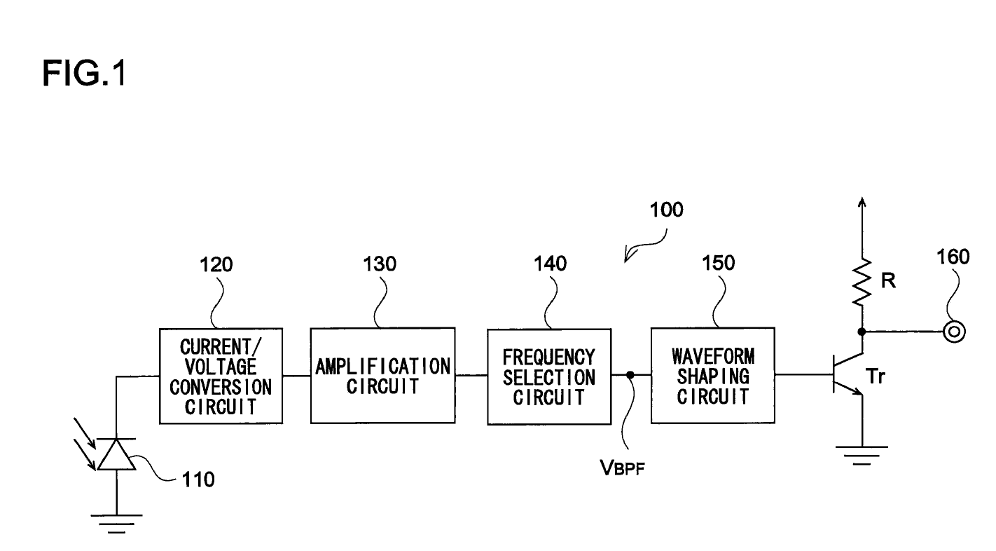

FIG. 1 is a diagram showing an outline of the internal configuration of a remote control receiver 100 embodying the invention. As shown in FIG. 1, the remote control receiver 100 is provided with: a photoreceptive device 110; a current/voltage conversion circuit 120; an amplification circuit 130; a frequency selection circuit 140; a waveform shaping circuit 150; a transistor Tr; and a resistor R.

The photoreceptive device 110 receives signals modulated with carrier waves having predetermined frequencies (in other words, optical signals whose emission is controlled according to control signals superimposed on carrier waves). The current/voltage conversion circuit 120 converts the signals received by the photoreceptive device 110 into voltage signals. The amplification circuit 130 amplifies the voltage signals obtained through the conversion by the current/voltage conversion circuit 120. The frequency selection circuit 140 selects, from among the voltage signals amplified by the amplification circuit 130, a voltage signal belonging to a predetermined frequency band, and then outputs the selected voltage signal. The waveform shaping circuit 150 outputs a pulse signal corresponding to the voltage signal selected by the frequency selection circuit 140. The transistor Tr and the resistor R invert the pulse signal outputted from the waveform shaping circuit 150, and outputs the inverted pulse signal to an output terminal 160.

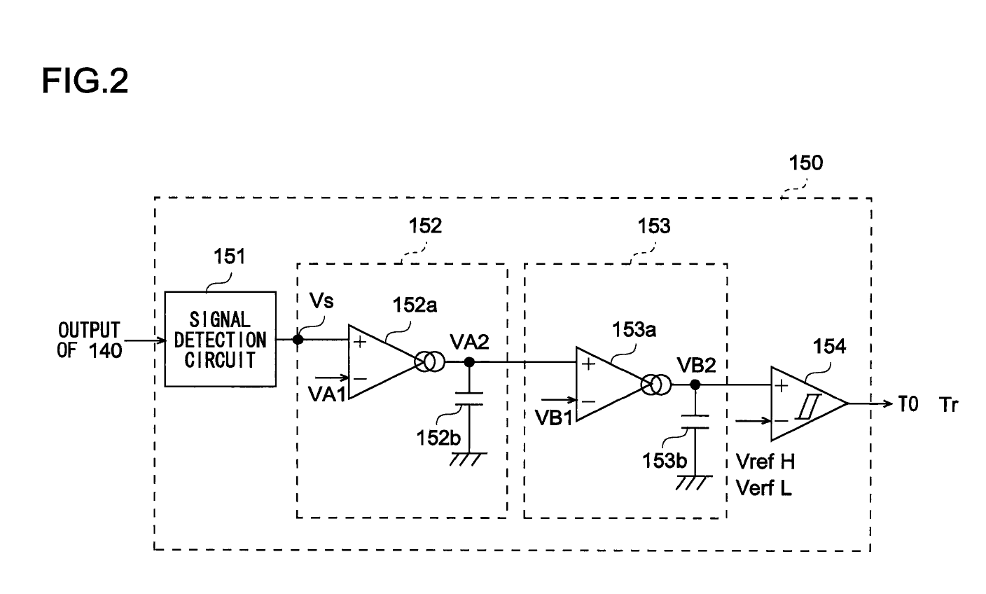

FIG. 2 is a diagram showing the internal configuration of the waveform shaping circuit 150 mentioned above. As shown in FIG. 2, the waveform shaping circuit 150 is provided with: a signal detection circuit 151; a plurality of integrating circuits connected in series with one another between the signal detection circuit 151 and a first comparison circuit 154; and the first comparison circuit 154. The signal detection circuit 151 eliminates a carrier wave from the signal selected by the frequency selection circuit 140. The first comparison circuit 154 compares the voltage signal outputted from, of the plurality of integrating circuits, the last-stage one (here, a second integrating circuit 153) with a first reference voltage (hereinafter simply the voltage Vref). The signal detection circuit 151 may be built as part of the frequency selection circuit 140.

The plurality of integrating circuits so operate that, when a voltage signal longer than a predetermined period and larger than a predetermined amplitude is fed to the first-stage integrating circuit, the voltage signal is made higher than the voltage Vref for the first comparison circuit 154 and is then outputted to the succeeding-stage integrating circuit and, when the voltage signal fed to the first-stage integrating circuit is shorter than the predetermined period, the voltage signal is made lower than the voltage Vref for the first comparison circuit 154 and is then outputted from the succeeding-stage integrating circuit. In this embodiment, there are provided two integrating circuits, namely a first integrating circuit 152 and a second integrating circuit 153. Needless to say, there may be provided three or more integrating circuits.

The first integrating circuit 152 is provided with a second comparison circuit 152a and a first integrating capacitor 152b. The second comparison circuit 152a compares the voltage of the voltage signal fed to the first integrating circuit 152 with a second reference voltage (hereinafter simply the voltage VA1), and, if the voltage of the voltage signal is higher than the voltage VA1, outputs a predetermined current. The first integrating capacitor 152b is charged with the predetermined current outputted from the second comparison circuit 152a. The charge voltage VA2 across the first integrating capacitor 152b is fed, as the output voltage of the first integrating circuit 152, to the second integrating circuit 153.

The second integrating circuit 153 is provided with a third comparison circuit 153a and a second integrating capacitor 153b. The third comparison circuit 153a compares the voltage VA2 of the voltage signal fed from the first integrating circuit 152 with a third reference voltage (hereinafter simply the voltage VB1), and, if the voltage VA2 of the voltage signal is higher than the voltage VB1, outputs a predetermined current. The second integrating capacitor 153b is charged with the predetermined current outputted from the third comparison circuit 153a. The charge voltage VB2 across the second integrating capacitor 153b is fed, as the output voltage of the second integrating circuit 153, to the non-inverting input terminal (+) of the first comparison circuit 154.

Thus, unless the voltage VS of the voltage signal fed from the signal detection circuit 151 to the first integrating circuit 152 is below a predetermined level, the third comparison circuit 153a yields no output (more precisely, its output logic level remains at a low level).

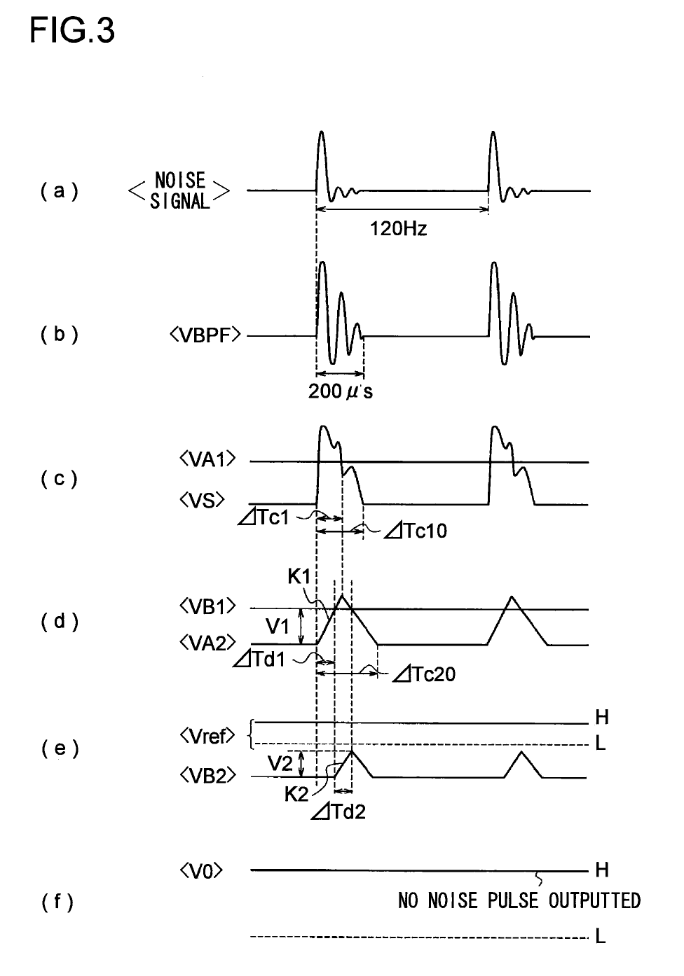

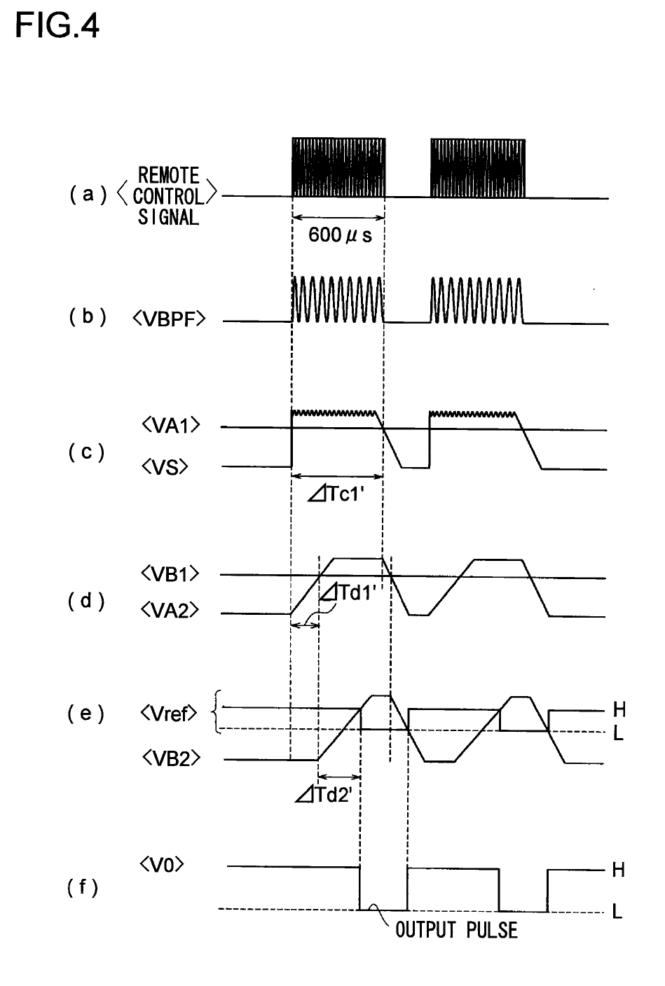

Next, the operation of the remote control receiver 100 will be described with reference to FIGS. 3 and 4. In the following description, a case where the remote control receiver 100 optically receives a noise signal and a case where the remote control receiver 100 optically receives a control signal will be discussed separately. In FIGS. 3 and 4, the following symbols are used: VBPF indicates the voltage outputted from the frequency selection circuit 140; VS indicates the voltage outputted from the signal detection circuit 151; VA1 indicates the second reference voltage for the first integrating circuit 152; VA2 indicates the charge voltage across the first integrating capacitor 152b; VB1 indicates the third reference voltage for the second integrating circuit 153; VB2 indicates the charge voltage across the second integrating capacitor 153b; Vref indicates the first reference voltage for the first comparison circuit 154; and Vo indicates the voltage outputted via the output terminal 160.

(1) When the remote control receiver 100 optically receives a noise signal

FIG. 3 is a diagram showing the waveforms of the voltages appearing at relevant points in the remote control receiver 100 when it optically receives a noise signal. When the photoreceptive device 110 optically receives a noise signal as shown in FIG. 3(a), a signal having a waveform as indicated by VBPF in FIG. 3(b) is outputted from the frequency selection circuit 140. The carrier wave of this signal VBPF is then eliminated by the signal detection circuit 151, so that a signal having a waveform as indicated by VS in FIG. 3(c) is outputted from the signal detection circuit 151.

When the voltage VS becomes higher than the voltage VA1 for the first integrating circuit 152 as shown in FIG. 3(c), for the period (hereinafter the period ΔTc1) for which the voltage VS remains higher than the voltage VA1, the first integrating capacitor 152b is charged, so that the charge voltage VA2 across the first integrating capacitor 152b rises as shown in FIG. 3(d). After this period ΔTc1, the first integrating capacitor 152b is discharged, so that the charge voltage VA2 falls. Here, the first integrating capacitor 152b is charged with the predetermined current only for the period ΔTc1 for which the voltage VS remains higher than the voltage VA1 as shown in FIG. 3(c), and, since the period ΔTc1 is shorter than the period ΔTc10 for which the signal component of the voltage VS is outputted, the maximum amplitude of the voltage VA2, that is, the voltage on the output side of the first integrating circuit 152, is smaller than the maximum amplitude of the voltage VS, that is, the voltage on the input side of the first integrating circuit 152. In this way, the first integrating circuit 152 reduces the noise signal fed thereto from the signal detection circuit 151.

Moreover, when the voltage VA2 becomes higher than the voltage VB1 for the second integrating circuit 153 as shown in FIG. 3(d), for the period for which the voltage VA2 remains higher than the voltage VB1, the second integrating capacitor 153b is charged, so that the voltage VB2 rises as shown in FIG. 3(e). After this period for which the voltage VA2 remains higher than the voltage VB1, the second integrating capacitor 153b is discharged by the predetermined current, so that the voltage VB2 falls as shown in FIG. 3(e). Here, the second integrating capacitor 153b is charged only for the period for which the voltage VA2 remains higher than the voltage VB1 as shown in FIGS. 3(d) and 3(e), and, since the period for which the voltage VA2 remains higher than the voltage VB1 is shorter than the period ΔTc20 for which the signal component of the voltage VA2 is outputted, the maximum amplitude of the voltage VB2, that is, the voltage on the output side of the second integrating circuit 153, is smaller than the maximum amplitude of the voltage VA2, that is, the voltage on the input side of the second integrating circuit 153. In this way, the second integrating circuit 153 further reduces the noise signal fed thereto from the first integrating circuit 152.

Furthermore, the voltage VB2 does not become higher than the high level VrefH of the voltage Vref for the first comparison circuit 154 as shown in FIG. 3(e), and thus the voltage Vo, that is, the voltage at the output terminal 160, remains at a high level.

In FIG. 3, the following symbols are additionally used: ΔTd1 in FIG. 3(d) indicates the period after the voltage VS starts to be fed to the first integrating circuit 152 until the voltage VA2 reaches the voltage VB1; V1 in FIG. 3(d) indicates the voltage of the voltage VA2 at the end of the period ΔTd1; ΔTd2 in FIG. 3(d) indicates the period for which the voltage VA2 remains higher than the voltage VB1; V2 in FIG. 3(e) indicates the voltage of the voltage VB2 at the end of the period ΔTd2; K1 and K2 in FIGS. 3(d) and 3(e) indicate the gradients of the voltages VA2 and VB2, respectively. The relationship among the period ΔTd1, the voltage V1, and the gradient K1 and the relationship among the period ΔTd2, the voltage V2, and the gradient K2 are expressed by formulae (1) and (2) noted below.

ΔTd1=V1/K1 (1)

ΔTd2=V2/K2 (2)

The relationship among the period ΔTc1 and formulae (1) and (2) noted above is expressed by formula (3) noted below.

ΔTc1<ΔTd1+ΔTd2=V1/K1+V2/K2 (3)

When formula (3) above is fulfilled, no erroneous pulse resulting from a noise signal is outputted via the output terminal 160. As shown in FIG. 3, since ΔTc1 is smaller than ΔTd1+ΔTd2, no erroneous pulse resulting from a noise signal is outputted via the output terminal 160.

As described above, only for the period for which the voltage VS (VA2) remains higher than the voltage VA1 (or VB1) as a result of having noise superimposed thereon, the first integrating capacitor 152b (or second integrating capacitor 153b) is charged. Thus, the first integrating capacitor 152b (or second integrating capacitor 153b) is charged for a shorter period than in a case where the first integrating capacitor 152b (or second integrating capacitor 153b) is not provided, and the voltage charged in the first integrating capacitor 152b (or second integrating capacitor 153b) is accordingly lower. Thus, thanks to the first and second integrating circuits 152 and 153 connected in series with each other, the voltage of noise fed to the first-stage integrating circuit, that is, the first integrating circuit 152, is made lower and lower, until it eventually becomes lower than the level VrefH. In this way, the waveform shaping apparatus 150 prevents the first comparison circuit 154 from outputting an erroneous pulse resulting from superimposition of noise.

Even when noise is superimposed, unless the voltage VS (or VA2) becomes higher than VA1 (or VB1), the second comparison circuit 152a (or third comparison circuit 153a) does not output the predetermined current. Thus, any variation in voltage resulting from noise smaller than the voltage VA1 (or VB1) is eliminated. In this way, the waveform shaping apparatus 150 prevents the first comparison circuit 154 from outputting an erroneous pulse resulting from superimposition of such noise. Operating in this way, the first integrating circuit 152 reduces a noise signal fed thereto from the signal detection circuit 151.

(2) When the remote control receiver 100 optically receives a control signal

FIG. 4 is a diagram showing the waveforms of the voltages appearing at relevant points in the remote control receiver 100 when it optically receives a control signal (in other words, when it receives an optical signal (remote control signal) whose emission is controlled according to a control signal superimposed on a carrier wave). When the photoreceptive device 110 optically receives a control signal as shown in FIG. 4(a), a voltage signal VBPF containing the control signal and a carrier component as shown in FIG. 4(b) is outputted from the frequency selection circuit 140. The carrier component of this signal VBPF is then eliminated by the signal detection circuit 151, so that a signal VS as shown in FIG. 4(c) is outputted from the signal detection circuit 151. Here, as shown in FIG. 4(c), a small part of the carrier component remains in the signal VS.

When the voltage VS becomes higher than the voltage VA1 for the first integrating circuit 152 as shown in FIG. 4(c), for the period (hereinafter the period ΔTc1′) for which the voltage VS remains higher than the voltage VA1, the first integrating capacitor 152b is charged, so that the charge voltage VA2 across the first integrating capacitor 152b rises as shown in FIG. 4(d). The period ΔTc1′ is so long that the first integrating capacitor 152b is charged for a period long enough to permit the voltage VA2 to reach the saturation voltage of the first integrating capacitor 152b. Then, after the period ΔTc1′, the first integrating capacitor 152b is discharged, so that the charge voltage VA2 falls.

Thereafter, when the voltage VA2 becomes higher than the voltage VB1 for the second integrating circuit 153 as shown in FIG. 4(d), for the period for which the voltage VA2 remains higher than the voltage VB1, the second integrating capacitor 153b is charged, so that the voltage VB2 rises as shown in FIG. 4(e). The period for which the voltage VA2 remains higher than the voltage VB1 is so long that the second integrating capacitor 153b is charged for a period long enough to permit the voltage VB2 to reach the saturation voltage of the second integrating capacitor 153b. Then, after the period for which the voltage VA2 remains higher than the voltage VB1, the second integrating capacitor 153b is discharged, so that the voltage VB2 falls as shown in FIG. 4(e). Moreover, when the voltage VB2 rises to become higher than the level VrefH as shown in FIG. 4(e), the voltage Vo, that is, the voltage at the output terminal 160, turns to a low level, and simultaneously the voltage Vref turns from the level VrefH to a lower level VrefL. Then, the second integrating capacitor 153b is discharged, and, when the voltage VB2 falls to become lower than the level VrefL, the voltage Vo, that is, the voltage at the output terminal 160, turns to a high level, and simultaneously the voltage Vref turns from the level VrefL back to the higher level VrefL.

Here, as shown in FIGS. 4(c) to 4(e), ΔTc1′ is larger than ΔTd1′+ΔTd2′, and therefore does not fulfill formula (3) noted above. Thus, a pulse signal corresponding to the control signal is outputted via the output terminal 160. In this way, the first comparison circuit 154 has hysteresis. Accordingly, even when the voltage VB2 is only slightly higher than the voltage Vref (the single threshold voltage with no hysteresis assumed), it is possible to ensure a predetermined output signal width without vacillation between a low and a high level. Operating as described above, the first and second integrating circuits 152 and 153 permit only a pulse signal corresponding to a control signal to be outputted via the output terminal 160, and prevents an erroneous pulse signal resulting from a noise signal from being outputted via the output terminal 160.

Needless to say, the waveform shaping circuit 150 of this embodiment may be applied not only to a remote control receiver 100 that optically receives a control signal modulated with a carrier wave having a predetermined frequency as specifically described above but also to any other kind of electric appliance (for example, a power supply circuit). The waveform shaping circuit 150 may be applied to a module that is formed integrally on a single circuit board. Such a module may be applied not only to a remote control receiver 100 but also to a non-optical transmitter/receiver. The control signals dealt with here are not limited to those for controlling a remote control receiver 100 itself, but may be those for controlling an electric appliance.

### INDUSTRIAL APPLICABILITY

The present invention is directed to a technique useful in reducing the influence of noise superimposed on a target signal, and can suitably be used in remote control receivers, remote control transmitter/receivers, power supply circuits, and the like.

1. A waveform shaping apparatus comprising:
a plurality of integrating circuits that are connected in series with one another, wherein, when a voltage signal longer than a predetermined period and larger than a predetermined amplitude is fed to a first-stage integrating circuit, the voltage signal is made higher than a first reference voltage and is then outputted to a succeeding-stage integrating circuit and, when the voltage signal fed to the first-stage integrating circuit is shorter than the predetermined period, the voltage signal is made lower than the first reference voltage and is then outputted from the succeeding-stage integrating circuit; and
a first comparison circuit that compares a voltage contained in the voltage signal outputted from the succeeding-stage integrating circuit with the first reference voltage and that then outputs a comparison result.

2. The waveform shaping apparatus of claim 1,
wherein the first-stage integrating circuit includes a second comparison circuit that compares the voltage of the voltage signal fed to the first-stage integrating circuit with a second reference voltage and that, when the voltage of the voltage signal is higher than the second reference voltage, outputs a predetermined current, and
wherein the succeeding-stage integrating circuit includes a third comparison circuit that compares the voltage of the voltage signal fed to the first-stage integrating circuit with a third reference voltage and that, when the voltage of the voltage signal is higher than the third reference voltage, outputs a predetermined current.

3. The waveform shaping apparatus of claim 2,
wherein the first integrating circuit includes an integrating capacitor that is charged with the predetermined current outputted from the second comparison circuit, and
wherein the second integrating circuit includes an integrating capacitor that is charged with the predetermined current outputted from the third comparison circuit.

4. A receiver comprising:
a photoreceptive device that optically receives control signals modulated with carrier waves having predetermined frequencies;
a voltage conversion circuit that converts the signals optically received by the photoreceptive device into voltage signals;
a frequency selection circuit that selects, from among the voltage signals, a voltage signal belonging to a predetermined frequency band and that then outputs the selected voltage signal; and
the waveform shaping apparatus of claim 1,
wherein the plurality of integrating circuits so operate that, of what is contained in the voltage signal outputted from the frequency selection circuit, any voltage shorter than a predetermined period is made lower than the first reference voltage so as not to be outputted from the succeeding-stage integrating circuit.

5. A module having the receiver of claim 4 formed integrally.

6. A remote control receiver or transmitter comprising the module of claim 5.

7. A waveform shaping apparatus comprising:
an integrating circuit array composed of a plurality of integrating circuits connected in series with one another; and
a first comparison circuit that compares a voltage of a voltage signal outputted from a last-stage integrating circuit included in the integrating circuit array with a first reference voltage and that then outputs a comparison result,
wherein the integrating circuit array so operates that, when a voltage signal longer than a predetermined period and larger than a predetermined amplitude is fed to a first-stage integrating circuit included in the integrating circuit array, the voltage signal is made higher than the first reference voltage and is then outputted from the last-stage integrating circuit and, when a voltage signal shorter than the predetermined period or smaller than the predetermined amplitude is fed to the first-stage integrating circuit, the voltage signal is made lower than the first reference voltage and is then outputted from the last-stage integrating circuit.

8. The waveform shaping apparatus of claim 7,
wherein the integrating circuit array is composed of a first integrating circuit, provided in a front stage, and a second integrating circuit, provided in a succeeding stage, connected in series with each other,
wherein the first integrating circuit includes a second comparison circuit that compares a voltage signal fed thereto with a second reference voltage and that, when the voltage signal is higher than the second reference voltage, outputs a predetermined current, and
wherein the second integrating circuit includes a third comparison circuit that compares a voltage signal fed thereto with a third reference voltage and that, when the voltage signal is higher than the third reference voltage, outputs a predetermined current.

9. The waveform shaping apparatus of claim 8,
wherein the first integrating circuit includes a first integrating capacitor that is charged with the predetermined current outputted from the second comparison circuit, and outputs as the voltage signal to the second integrating circuit a charge voltage across the first integrating capacitor, and
wherein the second integrating circuit includes a second integrating capacitor that is charged with the predetermined current outputted from the third comparison circuit, and outputs as the voltage signal to the first comparison circuit a charge voltage across the second integrating capacitor.

10. A receiver comprising:
a photoreceptive device that receives optical signals whose emission is controlled according to control signals each superimposed on a carrier wave having a predetermined frequency;
a voltage conversion circuit that converts the signals received by the photoreceptive device into voltage signals;
a frequency selection circuit that selects, from among the voltage signals, a voltage signal belonging to a predetermine frequency band and that then outputs the selected voltage signal; and
a waveform shaping apparatus that outputs a pulse signal corresponding to the voltage signal selected by the frequency selection circuit,
wherein the receiver has, as the waveform shaping apparatus, the waveform shaping apparatus of claim 7.

11. A reception module having all circuit elements constituting the receiver of claim 10 formed on a same circuit board.

12. A remote control receiver comprising the reception module of claim 11.
